(19) United States
(12) Patent Application Publication
(10) Pub. No.: US 2017/0072368 A1
(43) Pub. Date: Mar. 16, 2017

(54) POROUS MEMBRANE AND WATER PURIFIER

(71) Applicant: TORAY Industries, Inc., Tokyo (JP)

(72) Inventors: Shiro NOSAKA, Otsu-shi (JP); Yoshiyuki UENO, Otsu-shi (JP); Masahiro OSABE, Otsu-shi (JP)

(73) Assignee: TORAY Industries, Inc., Tokyo (JP)

(21) Appl. No.: 15/123,491

(22) PCT Filed: Mar. 10, 2015
(86) PCT No.: PCT/JP2015/056993

§ 371 Date: Sep. 2, 2016

(30) Foreign Application Priority Data
Mar. 11, 2014 (JP) 2014-047186

(51) Int. Cl. B01D 69/08; C02F 1/44; B01D 69/02

(52) U.S. Cl. CPC B01D 69/08; B01D 69/02; C02F 1/44; C02F 2303/04; C02F 2307/10; B01D 2325/022; B01D 2325/26; B01D 2325/04

(57) ABSTRACT

There is provided a porous membrane capable of achieving both virus-removing performance and water permeability. The porous membrane according to the present invention has an average pore minor axis diameter of 10 nm or more and 90 nm or less in at least one surface of the porous membrane; a thickness of 60 μm to 300 μm; and an overall adsorption capacity with respect to bacteriophage MS2 of 8×10⁹ PFU/g or more.

### TECHNICAL FIELD

The present invention relates to a porous membrane and a water purifier.

### BACKGROUND ART

Porous membranes are used in applications in which substances in liquid are separated depending on the pore size, and have been used in a wide variety of applications including medical applications such as hemodialysis and hemofiltration, water treatment applications such as home-use water purifiers and water purification treatment, and food production processes such as sterilization of foods and beverages and concentration of fruit juices.

Particularly, in the field of home-use water purifiers, for the purpose of avoiding the risk of contaminating drinking water with viruses and bacteria in districts and developing countries where water supply and sewerage systems are not fully equipped, home-use water purifiers having virus-removing performance have been demanded. Viruses which may be contaminated in tap water and can cause health impairment include norovirus, sapovirus, astrovirus, enterovirus, rotavirus, hepatitis A virus, hepatitis E virus, adenovirus, and poliovirus. Among these viruses, norovirus is as small as 38 nm and is extremely infectious, so that a human can be infected only with a small amount (10 to 100 cells) of the virus. Thus, since viruses can cause health impairment such as food poisoning when even a small amount of a virus is mixed, high removing performance is required for a water purifier.

Specifically, a porous membrane which can remove viruses at an extremely high removal rate has been demanded in applications of home-use water purifiers.

Heretofore, home-use water purifiers which remove impurities with a porous membrane have been used widely. In the water purifier, the substances to be removed are malodorous substances and bacteria contained in tap water, and activated carbon and a microfiltration membrane are mainly used as filtrating materials. However, activated carbon has poor virus-adsorbing performance, and microfiltration membranes are intended to remove bacteria having a diameter of 100 nm or larger, iron rust and the like. Therefore, these filtrating materials cannot remove small-sized viruses.

When the sizes of pores in a porous membrane are decreased for the purpose of removing viruses, the water permeability of the porous membrane deteriorates, which is a serious problem in applications of home-use water purifiers which are required to produce a large volume of water within a short time.

Virus-removing performance and water permeability, which are properties required for a water purifier, are greatly influenced by the pore diameters in the surface of the porous membrane, and there is such a mutually contradictory relationship between virus-removing performance and water permeability that virus-removing performance increases but water permeability deteriorates when the diameters of the pores are small.

As the method for improving virus-removing performance without decreasing the pore diameter, a method of adsorbing viruses to a porous membrane may be used. Since many of viruses are hydrophobic and carry a negative charge in a neutral region, viruses can be adsorbed to a porous membrane by hydrophobic interaction with the porous membrane or by electrostatic interaction with a porous membrane carrying a positive charge.

Patent Document 1 discloses a water purifier capable of removing viruses by adsorption. Patent Documents 2 and 3 disclose a porous membrane having a positive charge.

### PRIOR ART DOCUMENTS

### Patent Documents

Patent Document 1: Japanese Patent Application Publication Laid-open No. 5-84476

Patent Document 2: Japanese Patent Application Publication Laid-open No. 2006-341087

Patent Document 3: Japanese Patent Application Publication Laid-open No. 2010-53108

### SUMMARY OF THE INVENTION

### Problems to be Solved by the Invention

The porous membrane disclosed in Patent Document 1 does not have satisfactory virus-removing performance.

The porous membrane disclosed in Patent Document 2 contains a positively charged substance. However, there is no statement about a membrane structure suitable for removal of viruses. Further, there is no disclosure about virus-adsorption capacity of the porous membrane.

Patent Document 3 discloses a positively charged ultrafiltration membrane. However, there is no statement about a membrane structure and adsorption performance suitable for removal of viruses.

Heretofore, there is no porous membrane which can achieve both virus-removing performance and water permeability.

An object of the present invention is to provide a porous membrane which can achieve both virus-removing performance and water permeability.

### Solutions to the Problems

For the purpose of solving the above-mentioned problems, the present invention has the following configurations:

(1) A porous membrane having an average pore minor axis diameter of 10 nm to 90 nm in at least one surface of the porous membrane; a thickness of 60 μm to 300 μm; and an overall adsorption capacity with respect to bacteriophage MS2 of 8×10⁹ PFU/g or more;

(2) A porous membrane having an average pore minor axis diameter of 10 nm to 90 nm in at least one surface of the porous membrane; a thickness of 60 μm to 300 μm; and an adsorption capacity of 1×10¹⁰ PFU/m² or more when an aqueous bacteriophage MS2 solution is brought into contact with at least one surface of the porous membrane and is then allowed to flow.

As a preferred aspect of the invention mentioned above, the following configurations are provided:

(3) The porous membrane according to any one of the above-mentioned items, in which a pore diameter in a cross section of the membrane in a thickness direction varies in the thickness direction of the porous membrane;

(4) the porous membrane according to any one of the above-mentioned items, in which a layer having a pore diameter of 130 nm or less in a cross section of the membrane in the thickness direction exists with a thickness of 0.5 μm to 40 μm;

(5) the porous membrane according to any one of the above-mentioned items, in which near a surface of a side where the average pore minor axis diameter in the surface of the porous membrane is small, a layer having a pore diameter of 130 nm or less in a cross section of the membrane in the thickness direction exists with a thickness of 0.5 μm to 20 μm, and the layer has a pore having a pore diameter of 100 nm or more and 130 nm or less;

(6) The porous membrane according to any one of the above-mentioned items, in which near a surface of a side where the average pore minor axis diameter in the surface of the porous membrane is large, a layer having a pore diameter of 130 nm or less in a cross section of the membrane in the thickness direction exists with a thickness of 0.5 μm to 20 μm, and the layer has a pore having a pore diameter of 130 nm or less and 100 nm or more;

(7) The porous membrane according to any one of the above-mentioned items, in which an adsorption capacity when the aqueous bacteriophage MS2 solution is brought into contact with a surface on the side of the layer having a pore diameter of 130 nm or less in a cross section of the membrane in the thickness direction and is then allowed to flow is 1×10¹⁰ PFU/m² or more;

(8) The porous membrane according to any one of the above-mentioned items, in which pore diameters in a cross section of the membrane in the thickness direction increase from one surface toward the other surface to have at least one maximum pore diameter and then decrease;

(9) The porous membrane according to any one of the above-mentioned items, in which the porous membrane has an overall charge density of −30 μeq/g or more;

(10) The porous membrane according to any one of the above-mentioned items, containing a hydrophilic substance in an overall content in the porous membrane of 2% by mass or less;

(11) The porous membrane according to any one of the above-mentioned items, containing a second hydrophobic substance which is different from a first hydrophobic substance of a base material of the porous membrane, an overall content of the second hydrophobic substance in the porous membrane being 0.1% by mass or more of the total content of the first and second hydrophobic substances;

(12) The porous membrane according to any one of the above-mentioned items, in which at least one of two surfaces of the porous membrane has a zeta potential of 20 mV or more at pH 2.5;

(13) The porous membrane according to any one of the above-mentioned items, containing a hydrophilic substance in a content in at least one of two surfaces of the porous membrane of 18% by mass or less;

(14) The porous membrane according to any one of the above-mentioned items, in which a base material of the porous membrane contains a first hydrophobic substance and a second hydrophobic substance which is different from the first hydrophobic substance, and the content of the second hydrophobic substance in at least one of two surfaces of the porous membrane is 5% by mass or more;

(15) The porous membrane according to any one of the above-mentioned items, which is a hollow fiber membrane;

(16) The porous membrane, in which an average pore minor axis diameter in the inner surface of the porous membrane is smaller than that in the outer surface of the porous membrane;

(17) The porous membrane according to any one of the above-mentioned items, in which a liquid is allowed to flow from a side where the average pore minor axis diameter in the surface of the porous membrane is large toward a side where the average pore minor axis diameter is small;

(18) The porous membrane according to any one of the above-mentioned items, which is used in virus-removing applications;

(19) The porous membrane according to any one of the above-mentioned items, which is used for removing one or more viruses among norovirus, sapovirus, astrovirus, enterovirus, rotavirus, hepatitis A virus, hepatitis E virus, adenovirus, and poliovirus;

(20) A water purifier which includes one of the above-mentioned porous membranes.

### Effects of the Invention

According to the present invention, a porous membrane capable of achieving both virus-removing performance and water permeability can be provided as explained below. For example, when the porous membrane is included in a home-use water purifier, the water purifier can be excellent in compactness, and safe water having pathogenic viruses removed therefrom can be produced in a large quantity within a short time.

### EMBODIMENTS OF THE INVENTION

The present inventors have found that it is important to combine adsorption of viruses to a porous membrane and depth filtration within the porous membrane, in order to enhance water permeability and virus-removing performance, and have further recognized that a porous membrane having high adsorption capacity to viruses and having a large thickness of a portion where depth filtration occurs is required. For use in a product form having excellent compactness, the porous membrane is preferably in a hollow fiber shape capable of increasing the membrane area in unit volume.

In the present invention, it has been found that a porous membrane having an average pore minor axis diameter of 10 to 90 nm, a thickness of 60 μm to 300 μm, and an overall adsorption capacity with respect to bacteriophage MS2 of 8×10⁹ PFU/g or more, in at least one surface of the porous membrane, has high virus-removing performance and high water permeability.

To remove viruses by pores in the porous membrane, surface filtration in which substances are sieved through pores in the surface of the porous membrane and depth filtration in which particulate matters are captured by pores within the porous membrane may be carried out. Since the porous membrane for removing viruses must have a high virus removal rate of at least 99.99%, depth filtration is suitable which is not susceptible to deterioration of the removal rate due to variation in pore diameters or defects. When viruses are sieved through the porous membrane, the viruses pass through a narrow flow path, thereby increasing the opportunity for contact with the porous membrane. Thus, the viruses are easily adsorbed. As compared with filtration at the surface alone, depth filtration uses a longer flow path for filtering, resulting in a high virus removing effect due to virus adsorption. The thicker the porous membrane is, the more the pores within the membrane increase, so that virus removing performance is enhanced. On the other hand, the thicker membrane increases water resistance in the flow path, so that water permeability deteriorates. For that reason, the thickness of the porous membrane needs to be 60 μm or more, and is preferably 80 μm or more. On the other hand, the thickness of the porous membrane needs to be 300 μm or less, and is preferably 200 μm or less.

The porous membrane has a so-called symmetric membrane (hereinafter simply referred to as “symmetric membrane”) whose pore diameter hardly varies in the thickness direction, and a so-called asymmetric membrane” (hereinafter simply referred to as “asymmetric membrane”) whose pore diameter varies in the thickness direction. The structure in which the pore diameters vary in the thickness direction of the porous membrane includes both a region having small pore diameters, which contributes to removal of viruses, and a region having large pore diameters, which lowers water permeation resistance and contributes to the strength of the porous membrane, so that a porous membrane with high virus removing performance and water permeability is obtained. Therefore, the porous membrane is preferably an asymmetric membrane in which the pore diameters vary in the thickness direction of the porous membrane. As the method of forming an asymmetric membrane, a phase separation method is preferable, and an asymmetric membrane can be formed by a technique of inducing phase separation with a poor solvent or a technique of inducing phase separation by cooling a high-temperature membrane formation stock solution using a solvent having relatively poor solubility. For obtaining a hollow fiber membrane for applications of a compact-shaped product as in the present invention, a membrane is preferably formed by the technique of inducing phase separation with a poor solvent.

The hollow fiber membrane is formed by the following technique of inducing phase separation with a poor solvent. Using a bicylindrical nozzle, a membrane formation stock solution is infused into an outer slit portion of the bicylindrical nozzle, and a liquid containing, for example, poor solvent like water is infused into a central pipe of an inner portion. The membrane formation stock solution is discharged from the bicylindrical nozzle together with the infused liquid in the inner portion, and then freely runs in a predetermined zone, and led to a coagulation bath provided on the downstream side. The hollow fiber membrane coagulated in a hollow shape in the coagulation bath is washed with water and is then wound up.

During such spinning process, phase separation proceeds due to contact between the membrane formation stock solution and the poor solvent. The pore diameters then vary continuously in the thickness direction of the porous membrane from the surface which is in contact with the poor solvent, so that a porous membrane having the smallest pore diameter in the surface thereof is obtained, in which pores in the surface portion are dense while pores toward the inside of the membrane are loosened. The porous membrane has, therefore, a dense structured surface, and a layer near the surface is referred to as a dense layer. Such structure of the dense layer significantly affects virus removing performance. Since the growth rate of the pore varies depending on the concentration of the poor solvent, the pore diameter or the dense layer is adjusted effectively by varying the concentration of the poor solvent. The pore diameter in the surface and the thickness of the dense layer can be controlled by adjusting the concentration of the poor solvent to improve coagulation property.

When the time required for passing through a dry unit is too long, the pores on the side where the coagulation solution is not in contact with the membrane formation stock solution grow too large. Then, by immersing the membrane formation stock solution in the coagulation solution rapidly, a dense structure having small pore diameters can be formed. The growth of pores proceeds gradually from the surface of the membrane toward the inside of the membrane. Therefore, increase of the thickness of the membrane is also effective for forming a dense structure. At this time, in the dry unit, phase separation is induced by water contained in air. That is, the pore minor axis diameter in the surface on the side where the infused liquid having coagulation property is not in contact with the membrane formation stock solution, and the thickness of the dense layer can be controlled by adjusting the time for passing through the dry unit, the thickness of the membrane, and the temperature and humidity in the dry unit.

The time for passing the membrane formation stock solution through the dry unit depends on conditions that affect the progress of the phase separation, e.g., the composition of the membrane formation stock solution and the temperature, and is preferably 0.02 seconds or longer, and more preferably 0.14 seconds or longer. On the other hand, the time is preferably 0.40 seconds or shorter, and more preferably 0.35 seconds or shorter.

The membrane structure varies depending on the concentration of the poor solvent in the coagulation bath, and from the viewpoint of solidification of the membrane formation stock solution, the concentration of the poor solvent is preferably 20% by mass or more, and more preferably 50% by mass or more of all the solvents.

The term “poor solvent” refers to a solvent which cannot dissolve a polymer that primarily forms the structure of the porous membrane at the membrane formation temperature. The poor solvent may be appropriately selected depending on the kind of the polymer used, and water is suitably used as the poor solvent. The good solvent may be appropriately selected depending on the kind of the polymer used. When the polymer that forms the structure of the porous membrane is a polysulfone-based polymer, N,N-dimethylacetamide is suitably used as the good solvent.

When the viscosity of the membrane formation stock solution is increased, the growth of pores by the phase separation can be prevented, and therefore the thickness of the dense layer is increased. In order to increase the viscosity of the membrane formation stock solution, it can be mentioned as an example that the amount of a polymer that primarily forms the structure of the porous membrane and/or a hydrophilic polymer to be added if necessary is/are increased; a thickening agent is added; and the discharge temperature of the membrane formation stock solution is lowered. The viscosity of the membrane formation stock solution is preferably 0.5 Pa·s or more, and more preferably 1.0 Pa·s or more, at the discharge temperature. It is also preferably 20 Pa·s or less, and more preferably 10 Pa·s or less.

The pore diameter in a cross section of the membrane in the thickness direction is a diameter obtained when a pore is observed, the area of the pore is determined by, for example, image processing, and the determined area is then converted into a circle having the same area. The average pore diameter of a center layer of the porous membrane is preferably 1.5 times or more, and more preferably twice or more, the average pore diameter of at least one of surface layers of the porous membrane. The center layer is a layer having a total thickness of 2 μm including 1 μm each in the direction of the inner surface and the outer surface from the center of the thickness of the porous membrane, and the surface layer is a 2-μm thick layer in the direction from the outer surface or the inner surface of the membrane to the inside of the membrane.

In order to separate viruses depending on the size of the pore, it is necessary to make the pore minor axis diameter in the surface of the porous membrane smaller than the size of the viruses, thereby improving virus removing performance. On the other hand, a larger pore minor axis diameter in the surface of the porous membrane is advantageous from the viewpoint of water permeability. The depth filtration is effective at removing viruses due to adsorption of viruses. Therefore, even if the pore minor axis diameter in the surface of the porous membrane is larger than the diameter of the virus, the porous membrane can sufficiently remove viruses, thereby achieving both virus-removing performance and water permeability. The average pore minor axis diameter in at least one surface of the porous membrane needs to be 10 nm or more, preferably 15 nm or more, and more preferably 20 nm or more. On the other hand, the average pore minor axis diameter also needs to be 90 nm or less, and preferably 70 nm or less.

A longer pore major axis diameter in the surface of the porous membrane increases water flow paths, so that water permeability is enhanced. Therefore, it is preferable that the pore major axis diameter in the surface of the porous membrane is 2.5 times or more the pore minor axis diameter.

In the present invention, bacteriophage MS2 is used for evaluation of the porous membrane in terms of adsorption performance and removing performance to viruses. Bacteriophage MS2 having a diameter of about 27 nm is categorized into a small-sized virus, among viruses. Furthermore, bacteriophage MS2 is hydrophobic and carries a negative charge, and is close in the charge state to a pathogenic virus. For this reason, it can be said that, by setting the removing performance to bacteriophage MS2 as a guide, the porous membrane has higher removing performance to many pathogenic viruses than that to bacteriophage MS2.

The method for increasing overall adsorption capacity of the porous membrane to bacteriophage MS2 includes a method of increasing the charge of the porous membrane to thereby enhance the electrostatic interaction between the porous membrane and viruses; and a method of increasing overall hydrophobicity of the porous membrane to enhance the hydrophobic interaction between the porous membrane and viruses.

By increasing the charge of the porous membrane to make the charge positive, an electrostatic interaction between the porous membrane and the viruses bearing negative charges is enhanced. Furthermore, even by bringing the charge of the porous membrane close to neutral, the repulsion between the negative charges becomes weak, which in turn accelerates adsorption of viruses due to the hydrophobic interaction. On the other hand, when the positive charge is too large, more coexisting substances other than viruses are adsorbed to the porous membrane, and the adsorption site thereby becomes filled with the coexisting substances, resulting in deterioration of the virus adsorption capacity of the porous membrane. Therefore, for the purpose of improving the virus-removing performance, the porous membrane preferably has a charge density of −30 μeq/g or more, and more preferably 0 μeq/g or more. On the other hand, the porous membrane preferably has a charge density of 40 q/g or less.

As the method of increasing the charge of the porous membrane, a method of using a polymer of a positive charge in the base material of the porous membrane; a method of using a copolymer which has a positive charge unit; a method of adding a positively charged substance to the membrane formation stock solution at the time of forming the porous membrane; a method of bringing a solution of a positively charged substance into contact with the porous membrane to adsorb the positively charged substance to the porous membrane; or a method of bringing a solution of a positively charged substance into contact with the porous membrane, followed by chemically fixing the positively charged substance, may be used. Of these, the method of chemically fixing a positively charged substance to the porous membrane is preferably used, because such method does not affect the formation of the porous membrane structure and there is no concern of deterioration in performance due to elution of the positively charged substance at the time when water is made to pass through the porous membrane.

Here, the positively charged substance is, if defined, preferably a substance having a charge density of 1 meq/g or more at pH 4.5. In particular, a substance having a functional group, such as a primary amino group, a secondary amino group, a tertiary amino group, a quaternary amino group, a pyrrole group, a pyrazole group, an imidazole group, an indole group, a pyridine group, a pyridazine group, a quinoline group, a piperidine group, a pyrrolidine group, a thiazole group, and a purine group is suitably used. The positively charged substances may be used in combination of two or more kinds.

When a polymer is used as the positively charged substance, only a portion of the main chain of the polymer is bonded to a material which forms the porous membrane, which enables a larger number of positively charged groups to be introduced per unit area of the porous membrane, resulting in increase of the charge density of the porous membrane. Therefore, a polymer is preferably used as the positively charged substance. The polymer preferably has a molecular weight of 1,000 or more and 80,0000 or less. Although it is not specifically limited, specific examples thereof include polyethyleneimine, polyvinylamine, polyallylamine, diethylaminoethyl-dextran, polylysine, polydiallyldimethylammonium chloride, and a copolymer of vinylimidazolium methochloride and vinyl pyrrolidone.

Positions to which positive charges are imparted in the porous membrane vary depending on the relationship between the size of the positively charged substance and the pore diameter in the porous membrane. Using a positively charged substance having a larger size than the pore diameters in both surfaces of the porous membrane, the positively charged substance can be imparted only to the surface of the porous membrane. Using a positively charged substance which is smaller than the pore in both surfaces of the porous membranes, the positively charged substance can be imparted to the entire porous membrane including the inside of the membrane. Using a positively charged substance which is larger than the pore in one surface of the porous membrane but smaller than the pore in the other surface thereof, a larger amount of positively charged substance can be imparted near one of the surfaces of the porous membrane. The amount of the positively charged substance to be imparted can be varied stepwise in the thickness direction of the porous membrane by varying the diffusion rate of the positively charged substance. Further, the porous membrane is used as a module, and a positively charged substance which is larger than the pore in one surface of the porous membrane but smaller than the pore in the other surface thereof is allowed to pass through under filtration from the side where the average pore minor axis diameter in the surface of the porous membrane is large toward the side where such average diameter is small, thereby enabling the positively charged substance to be imparted at high concentration to the inside of the membrane near the side where the average pore minor axis diameter in the surface of the porous membrane is small. Conversely, a positively charged substance which is larger than the pore in the surface of the porous membrane is allowed to pass through the porous membrane under filtration, thereby enabling the positively charged substance to be condensed and imparted to the surface of the porous membrane.

As mentioned above, the method for improving overall adsorption capacity of the porous membrane to bacteriophage MS2 includes a method of increasing overall hydrophobicity of the porous membrane to enhance the hydrophobic interaction between the porous membrane and viruses. As the method of increasing overall hydrophobicity of the porous membrane, using a highly hydrophobic material; decreasing the content of the hydrophilic substance; or adding a hydrophobic substance may be used. Since the porous membrane, which contains a hydrophobic substance alone as a base material, is difficult to permeate water, a hydrophilic substance is preferably incorporated in order to improve water permeability. While a lower content of the hydrophilic substance increases hydrophobicity of the porous membrane, thereby achieving higher virus-removing performance, a higher content of the hydrophilic substance decreases hydrophobicity of the porous membrane, which lowers water permeation resistance, thereby improving water permeability. Therefore, the overall content of the hydrophilic substance in the porous membrane is preferably 2% by mass or less, and more preferably 1.5% by mass or less. On the other hand, the overall content thereof is preferably 0.1% by mass or more.

As the method of incorporating a hydrophilic substance in the porous membrane, a method of using a copolymer of a hydrophobic substance which is a base material of the porous membrane; a method of adding a hydrophilic substance to a membrane formation stock solution at the time of forming a porous membrane; a method of bringing a solution of a hydrophilic substance into contact with the porous membrane to adsorb the hydrophilic substance to the porous membrane; or a method of bringing a solution of a hydrophilic substance into contact with the porous membrane, followed by chemically fixing the hydrophilic substance, may be used. Of these, the method of adding a hydrophilic substance to a membrane formation stock solution at the time of forming a porous membrane is preferably used, because the hydrophilic substance serves as a pore-forming agent at the time of forming the structure of a porous membrane, which is effective for increasing pores of the porous membrane in number.

It is required that the method for determining the content of the hydrophilic substance is selected depending on the kind of the substance. The content of the hydrophilic substance can be determined by a method such as an elemental analysis method.

The hydrophilic substance as mentioned in the present invention may be a homopolymer formed only from a hydrophilic unit or a copolymer having a part of the hydrophilic unit. A polymer composed of the hydrophilic unit alone is a repeat unit which is readily soluble in water, and preferably has a solubility of 10 g/100 g or more in 20° C. pure water.

Although it is not specifically limited, specific examples of the hydrophilic substance include polyethylene glycol, polyvinyl pyrrolidone, polyethyleneimine, polyvinyl alcohol, and derivatives thereof. The hydrophilic substance may be copolymerized with other monomers.

The hydrophilic substance may be appropriately selected depending on the affinity with a material of the porous membrane or the solvent. When the material of the porous membrane is a polysulfone-based polymer, polyvinylpyrrolidone is preferably used because of its high compatibility with the polysulfone-based polymer.

There is a method of adding to the porous membrane a second hydrophobic substance which is different from the first hydrophobic substance of a base material. For the purpose of enhancing the virus adsorption capacity, although reduction of the content of the hydrophilic substance is limited, the hydrophobicity of the porous membrane can be improved by incorporating the second hydrophobic substance.

Specific examples of the basic hydrophobic substance (the first hydrophobic substance when the second hydrophobic substance is separately incorporated) used as the base material of the porous membrane include polysulfone-based polymers, polystyrene, polyurethane, polyethylene, polypropylene, polycarbonate, polyvinylidene fluoride, and polyacrylonitrile, but are not limited thereto. Of these, polysulfone-based polymers are suitably used because they allow the porous membrane to be easily formed. A polysulfone-based polymer has an aromatic ring, a sulfonyl group, and an ether group in its main chain, and examples thereof include polysulfone, polyether sulfone, and polyallyl ether sulfone. The polysulfone represented by the following chemical formula (1) or (2) is suitably used, but the polysulfone is not limited thereto in the present invention. In the formulae, n represents an integer of, for example, 50 to 80.

### [Chem. 1]

The method of incorporating a second hydrophobic substance in the porous membrane includes a method of adding a second hydrophobic substance to a membrane formation stock solution at the time of forming a porous membrane; a method of bringing a solution of a second hydrophobic substance into contact with the porous membrane to adsorb the second hydrophobic substance to the porous membrane; and a method of bringing a solution of a hydrophilic substance into contact with the porous membrane, followed by chemically fixing the hydrophilic substance.

The second hydrophobic substance as mentioned in the present invention may be a homopolymer formed only from a hydrophobic unit or a copolymer having a part of the hydrophobic unit. A polymer composed of the hydrophobic unit alone is a substance which is sparingly soluble in water, and preferably has a solubility of less than 10 g/100 g in 20° C. pure water.

When the second hydrophobic substance is incorporated in the porous membrane, the content of the second hydrophobic substance is preferably 0.1% or more of the total content of the first and second hydrophobic substances. It is required that the method for determining the content of the second hydrophobic substance is selected depending on the kind of the substance. The content of the second hydrophobic substance can be determined by a method such as an elemental analysis method.

As the second hydrophobic substance, a substance different from that used as the first hydrophobic substance is used, and the polymer explained as the first hydrophobic substance can be used. Other examples of the second hydrophobic substance include polysulfone, polystyrene, vinyl acetate, polymethylmethacrylate, and derivatives thereof. The second hydrophobic substance may be copolymerized with other monomers.

Viruses are removed by depth filtration occurring within the porous membrane, mostly at a layer having a pore diameter capable of sieving viruses within the membrane. The maximum pore diameter contributable to removal of matters having a size of 38 nm, which is the diameter of pathogenic norovirus, is about 130 nm, and the depth filtration of viruses occurs mostly at a layer having a pore diameter of 130 nm or less also existing in the depth of the porous membrane in the thickness direction. Therefore, such layer has virus adsorption capacity, which can improve virus-removing performance. When the cross section of the membrane in the thickness direction is observed, the layer having a pore diameter of 130 nm or less exists near the surface in the structure where the pore diameter in the surface is small but gradually increases toward the inside of the membrane. Therefore, it is more preferable that the porous membrane has adsorption capacity to bacteriophage MS2 near the surface. Specifically, when an aqueous bacteriophage MS2 solution is brought into contact with at least one surface of the porous membrane and is then allowed to flow, the adsorption capacity thus obtained needs to be 1×10¹⁰ PFU/m² or more, and preferably 2×10¹⁰ PFU/m² or more. In a product form to be miniaturized like a home water purifier, since a large membrane area is allowed to be provided, filtration is carried out preferably in the direction from the outer surface of the membrane to the inner surface of the membrane, and the adsorption capacity is preferably enhanced when the solution including viruses is brought into contact with the outer surface and is then allowed to flow.

To stably enhance the virus-removing performance, the porous membrane has adsorption performance near the surface of the membrane as described above, as well as adsorption performance within the membrane in combination, that is, the porous membrane has a predetermined virus adsorption capacity or higher in the overall membrane, which in turn achieves a higher effect. Specifically, the overall adsorption capacity of the porous membrane to bacteriophage MS2 needs to be 8×10⁹ PFU/g or more, and is preferably 1×10¹⁰ PFU/g or more.

Further, it is more preferable that the surface having the adsorption capacity mentioned above is a surface on the side of the layer having a pore diameter of 130 nm or less in a cross section of the membrane in the thickness direction. Although an aqueous bacteriophage MS2 solution is allowed to flow so as to be brought into contact with only one surface of the porous membrane without filtration, bacteriophage MS2 substantially enters in the membrane by means of diffusion, so that the adsorption capacities of the surface and of the layer near the surface which contributes to depth filtration are to be determined.

When the zeta potential, which indicates a charge state on the surface of the porous membrane, is increased, the adsorption capacity to bacteriophage MS2 at the surface of the porous membrane can be enhanced. On the other hand, excessively high zeta potential increases adsorption of coexisting substances other than viruses to the porous membrane. Thus, the coexisting substances are adsorbed to the adsorption site, resulting in deterioration of the virus adsorption capacity of the porous membrane. Either or both surfaces of the porous membrane preferably have a zeta potential of 20 mV or more, and more preferably 25 mV or more, at pH 2.5. On the other hand, either or both surfaces of the porous membrane preferably have a zeta potential of 50 mV or less, and more preferably 35 mV or less, at pH 2.5.

When the zeta potential is measured at pH 2.5, the zeta potential negates the influence of the negatively charged group which exists on the surface of the porous membrane, and becomes susceptible to the volume of the positively charged group. The zeta potential indicates an average charge on the surface of the porous membrane. The negatively charged group and the positively charged group coexist on the surface of the porous membrane, and the positively charged groups which locally exist and viruses cause an interaction. Therefore, in order to grasp the virus adsorption capacity at the surface of the porous membrane, the zeta potential value determined at pH 2.5, which is susceptible to the volume of the positively charged group, is required.

When the content of the hydrophilic substance in the surface of the porous membrane is reduced, the adsorption capacity to bacteriophage MS2 at the surface of the porous membrane can be enhanced. The content of the hydrophilic substance in either or both surfaces of the porous membrane is preferably 18% by mass or less, and more preferably 15% by mass or less.

It is required that the method for determining the content of the hydrophilic substance in the surface of the porous membrane is selected depending on the kind of the substance. The content of the hydrophilic substance can be determined by a method such as x-ray photoelectron spectroscopy.

When the content of the second hydrophobic substance in the surface of the porous membrane is increased, the adsorption capacity to bacteriophage MS2 at the surface of the porous membrane can be enhanced. The content of the second hydrophobic substance in at least one of the two surfaces is preferably 5% by mass or more, and more preferably 7% or more, in the base material of the porous membrane surface.

It is required that the method for determining the content of the second hydrophobic substance in the surface of the porous membrane is selected depending on the kind of the substance. The content of the second hydrophobic substance can be determined by a method such as x-ray photoelectron spectroscopy.

The virus-removing performance of the porous membrane is improved by increasing the thickness of the layer having a pore diameter of 130 nm or less, where depth filtration occurs in a cross section of the membrane in the thickness direction. On the other hand, water permeation resistance of the porous membrane lowers by decreasing the thickness of such layer, so that water permeability is enhanced. Therefore, the layer having a pore diameter of 130 nm or less in a cross section of the membrane in the thickness direction preferably has a thickness of 0.5 μm or more, and more preferably 1 μm or more. On the other hand, such layer preferably has a thickness of 40 μm or less, and more preferably 30 μm or less.

In order to improve virus-removing performance, it is preferable that the layer having a pore diameter of 130 nm or less in a cross section of the membrane in the thickness direction exists near both surfaces of the membrane. That is, preferable is a structure in which pore diameters increase from one surface in a cross section of the membrane in the membrane direction toward the other surface, and then decrease after a part having at least one maximum pore diameter.

Near the surface on the side where the average pore minor axis diameter is small, the layer having a pore diameter of 130 nm or less in a cross section of the membrane in the thickness direction preferably has a thickness of 0.5 μm or more, more preferably 1 μm or more, even more preferably 1.5 μm or more, and even more preferably 2 μm or more. On the other hand, such layer preferably has a thickness of 20 μm or less, and more preferably 15 μm or less. The above-mentioned layer preferably has pores having a pore diameter of 130 nm or less and 100 nm or more.

Near the surface on the side where the average pore minor axis diameter is large, the layer having a pore diameter of 130 nm or less in a cross section of the membrane in the thickness direction preferably has a thickness of 0.5 μm or more, more preferably 1 μm or more, even more preferably 1.5 μm or more, and even more preferably 2 μm or more. On the other hand, such layer preferably has a thickness of 20 μm or less, and more preferably 15 μm or less. The above-mentioned layer preferably has pores having a pore diameter of 130 nm or less and 100 nm or more.

As the method of controlling the pore diameter and the thickness near both surfaces of the porous membrane, a method of controlling the formation of pores by phase separation occurring in both surfaces to form an integral membrane structure in which the pore diameters vary continuously; or a method of forming at least two layers having different materials or different compositions from each other to produce a composite membrane, may be used. A porous membrane having an integral membrane structure does not have a structurally weak part which is a layer-layer interface, compared with a composite membrane, and the structure of the porous membrane is hardly broken even under a high water pressure. For these reasons, it is preferred that the membrane structure is an integral structure.

As for the depth filtration of viruses, when viruses enter into the inside of the membrane, viruses are adsorbed to the membrane simultaneously with filtration. Therefore, it is preferable that water containing viruses is allowed to flow toward the side where the average pore minor axis diameter in the surface of the porous membrane is small from the side where the average pore minor axis diameter in the surface of the porous membrane is large.

A small porosity in the porous membrane increases the contact area between the porous membrane and viruses, so that viruses are easily adsorbed to the porous membrane, which in turn enhances the virus-removing performance. On the other hand, increase of the porosity lowers water permeation resistance, so that water permeability is enhanced. For these reasons, the porous membrane preferably has a porosity of 50% or more, and more preferably 60% or more. On the other hand, the porous membrane preferably has a porosity of 90% or less, and more preferably 85% or less.

The porosity of the porous membrane is a percentage value of the volume of pores relative to the apparent volume of the porous membrane which is expressed by a dimension. The porosity can be calculated from the apparent volume which is calculated from the dimension of the porous membrane and the true volume of the porous membrane which is calculated from the mass and density of the porous membrane.

A low opening ratio in the surface of the porous membrane increases the contact area with viruses in the surface, so that viruses are easily adsorbed to the porous membrane, which in turn enhances the virus-removing performance. On the other hand, a high opening ratio in the surface of the porous membrane increases water flow paths, so that water permeability is enhanced. For these reasons, in the surface of the side where the average pore minor axis diameter in the surface of the porous membrane is small, the surface opening ratio is preferably 0.5% or more, and more preferably 1% or more. On the other hand, the surface opening ratio is preferably 15% or less, and more preferably 10% or less.

In order to increase the opening ratio, it is effective to increase the amount of the hydrophilic substance to be added to the membrane formation stock solution.

The opening ratio in the surface can be determined from an image of the porous membrane surface which is observed with a SEM. An image observed at a magnification of 10000 times is processed and then subjected to binary coded processing, wherein a structural part has a light brightness value and a pore part has a dark brightness value. Subsequently, the percentage of the area of the dark brightness value relative to the measured area is calculated, and is employed as an opening ratio.

When the pore diameter in a cross section of the membrane varies in the thickness direction, it is preferred that the average pore minor axis diameter in the inner surface of the hollow fiber membrane is smaller than the average pore minor axis diameter in the outer surface of the hollow fiber membrane in order to facilitate controlling the structure of the surface on the side where the average pore minor axis diameter is small, the structure having great influence on virus-removing performance.

When the porous membrane is a hollow fiber membrane, the pressure resistance of the membrane is in correlation with the ratio of the thickness of the membrane to the inner diameter of the membrane, and the pressure resistance increases when the ratio of the thickness to the inner diameter (thickness/inner diameter) is large. When the inner diameter and the thickness of the membrane are reduced, the size of a water purifier including the porous membrane can be reduced, and the pressure resistance of the porous membrane can be improved. However, when the inner diameter of the membrane is reduced to an excessive degree, the water permeability deteriorates, so that it becomes difficult for small-sized products to achieve the desired water penetration volume. For reducing the size of a water purifier and improving the virus-removing performance, water permeability, and pressure resistance, the thickness/inner diameter of the hollow fiber membrane is preferably 0.35 or more. On the other hand, the thickness/inner diameter of the hollow fiber membrane is preferably 1.00 or less, and more preferably 0.7 or less.

Since the porous membrane of the present invention has high virus-removing performance and high water permeability, it is suitably used in virus-removing applications. In particular, the porous membrane of the present invention is suitably used for the purpose of removing one or more viruses of norovirus, sapovirus, astrovirus, enterovirus, rotavirus, hepatitis A virus, hepatitis E virus, adenovirus, and poliovirus. Further, the porous membrane of the present invention is included in a water purifier and is suitably used in applications in which a large volume of water is processed within a short time.

As for the porous membrane of the present invention, when the pore diameter in a cross section of the membrane in the thickness direction varies in the thickness direction of the porous membrane, it is preferable that a liquid is allowed to flow from the side where the average pore minor axis diameter in the surface of the porous membrane is large toward the side where the average pore minor axis diameter is small, because more viruses enter into the inside of the membrane, to thereby effectively achieve virus adsorption capacity.

### EXAMPLES

In the following, while the present invention will be described with reference to examples, the present invention is not limited to any of them.

(1) Measurement of Water Permeability

A measurement example in which the porous membrane is a hollow fiber membrane will be mentioned below. Hollow fiber membranes were charged in a housing having an inner diameter of 5 mm with pores for a reflux provided on both ends, in such a manner that the effective length of the hollow fiber membrane became 17 cm, and the number of fibers was adjusted in such a manner that the membrane area of the outer surface of the hollow fiber membrane became 0.004 m². The membrane area can be calculated in accordance with the equation shown below.

Membrane area (m²)=(outer diameter (μm))×π×17 (cm)×(number of fibers)×0.00000001

Both ends of the hollow fiber membrane were potted to each other using an epoxy resin-based chemical reaction-type adhesive agent “QUICK MENDER” (trade name) (manufactured by Konishi Co., Ltd.), and the bonded product was cut to open, thereby producing a hollow fiber membrane module. Subsequently, the inside and the outside of the hollow fiber membrane in the module were washed with distilled water at 100 ml/min for 1 hour. A water pressure of 13 kPa was applied onto the outside of the hollow fiber membrane, and the filtration amount of water flowing out to the inside of the hollow fiber membrane per unit time was measured. Water permeability (UFR) was calculated in accordance with equation (1) shown below.

UFR(ml/hr/Pa/m²)=Q_{w}/(P×T×A) (1)

wherein Q_{w} represents a filtration amount (mL), T represents an outflow time (hr), P represents a pressure (Pa), and A represents the membrane area (m²).

(2) Measurement of Virus-Removing Performance

A measurement example in which the porous membrane is a hollow fiber membrane will be mentioned below. The evaluation was carried out using the module that had been subjected to the evaluation (1).

A virus stock solution was prepared in such a manner that cells of bacteriophage MS2 (Bacteriophage MS-2 ATCC 15597-B1) each having a size of about 27 nm were added to distilled water so that the solution would have a concentration of about 1.0×10⁷ PFU/ml. As the distilled water, distilled water was used which was produced using a pure water production apparatus “AUTO STILL” (registered trade mark) (manufactured by Yamato Scientific Co., Ltd.), and then sterilized with steam under a high pressure at 121° C. for 20 minutes. The entire volume of the virus stock solution was filtrated by supplying the virus stock solution from the outer surface of the module toward a hollow part in the module under conditions of a temperature of about 20° C. and 400 kPa. The filtrate was collected in such a manner that 150 ml of a first flow of permeated liquid was discarded, then 5 ml of a permeated liquid for measurement was collected, and then the collected permeated liquid was diluted with distilled water at dilution rates of 0, 100, 10000 and 100000. The concentration of bacteriophage MS2 was determined in accordance with the method of Overlay agar assay, Standard Method 9211-D (APHA, 1998, Standard methods for the examination of water and wastewater, 18th ed.) by seeding 1 ml of each of the diluted permeated liquids onto an assay petri dish and then counting the number of plaques. Plaques are masses of bacteria that have been infected with viruses and died, and can be counted as dot-like plaques. The virus-removing performance was expressed in terms of a log reduction value (LRV) for viruses. For example, an LRV of 2 is −log₁₀x=2, i.e., 0.01, and means that the residual concentration of viruses is 1/100 (removal rate: 99%). When no plaque was counted in a permeated liquid, it means that the permeated liquid has an LRV of 7.0.

(3) Measurement of Overall Virus Adsorption Capacity of Porous Membrane

In 40 ml of an aqueous solution of bacteriophage MS2 having a concentration of 1×10⁹ PFU/ml, 0.05 g of a porous membrane was immersed, and was shaken at 20° C. at 150 rpm for 30 minutes. The solutions before and after the adsorption experiment were then sampled. The sampled solution was diluted with distilled water at dilution rates of 0, 100, 10000 and 100000. The concentration of bacteriophage MS2 was determined in accordance with the method of Overlay agar assay, Standard Method 9211-D (APHA, 1998, Standard methods for the examination of water and wastewater, 18th ed.) by seeding 1 ml of each of the diluted permeated liquids onto an assay petri dish and then counting the number of plaques. Plaques are masses of bacteria that have been infected with viruses and died, and can be counted as dot-like plaques. The virus adsorption capacity was calculated by equation (2).

Adsorption Capacity(PFU/g)=(Cp−Ca)×40 ml/m (2)

wherein Cp represents a concentration (PFU/ml) before adsorption; Ca represents a concentration (PFU/ml) after adsorption; and m represents a mass (g) of a porous membrane.

(4) Measurement of Virus Adsorption Capacity when Viruses were Brought into Contact With One Surface of Porous Membrane and then Allowed to Flow

A measurement example in which the porous membrane is a hollow fiber membrane will be mentioned below.

Hollow fiber membranes were charged in a housing having an inner diameter of 10 mm with pores for a reflux provided on both ends, in such a manner that the effective length of the hollow fiber membrane became 10 cm, and the number of fibers was adjusted in such a manner that the membrane area of the outer surface of the hollow fiber membrane became 0.03 m². The membrane area can be calculated in accordance with the equation shown below.

Membrane area (m²)=(outer diameter (μm))×π×10 (cm)×(number of fibers)×0.00000001

Both ends of the hollow fiber membrane were potted to each other using an epoxy resin-based chemical reaction-type adhesive agent “QUICK MENDER” (trade name) (manufactured by Konishi Co., Ltd.), and the bonded product was cut to open, thereby producing a hollow fiber membrane module.

Subsequently, 40 ml of an aqueous bacteriophage MS2 solution having a concentration of 1×10⁹ PFU/ml was circulated at a temperature of 20° C. at a rate of 2 ml/min for 30 minutes from a pore for reflux on one side toward a pore for reflux on the other side so as to be brought into contact only with the outer surface of the hollow fiber membrane without filtration. The samples before and after the circulation were diluted with distilled water at dilution rates of 0, 100, 10,000 and 100,000. The concentration of bacteriophage MS2 was determined in accordance with the method of Overlay agar assay, Standard Method 9211-D (APHA, 1998, Standard methods for the examination of water and wastewater, 18th ed.) by seeding 1 ml of each of the diluted samples onto an assay petri dish and then counting the number of plaques. Plaques are masses of bacteria that have been infected with viruses and died, and can be counted as dot-like plaques. The virus adsorption capacity was calculated by equation (3).

Adsorption Capacity(PFU/m²)=(Cp−Ca)×40 ml/A (3)

wherein Cp represents a concentration (PFU/ml) before circulation; Ca represents a concentration (PFU/ml) after circulation; and A represents a membrane area (m²) of an outer surface of a porous membrane.

(5) Measurement of Pore Diameters of Surface

Each of both surfaces of a porous membrane was observed with a scanning electron microscope (SEM) (S-5500, manufactured by Hitachi High-Technologies Corporation) at a magnification of 50,000 times, and an image thereof was captured in a computer. The size of the captured image was 640 pixels×480 pixels. When the porous membrane was a hollow fiber membrane and the inner surface of the hollow fiber membrane was to be observed, the hollow fiber membrane was cut into a semicircular shape to be observed.

The SEM image was cut into a 1 μm×1 μm piece and the image analysis of the piece was carried out using image processing software. A threshold value was determined by binary coded processing in such a manner that a structural part had a light brightness value and the parts other than the structural part had a dark brightness value, thereby obtaining an image in which the light brightness region was seen as white and the dark brightness region was seen as black. When the structural part could not be distinguished from the parts other than the structural part due to the contrast difference in the image, areas in which the contrasts were same as each other were cut out, the areas were separately subjected to binary coded processing, and then the cut areas were put back together to forma single image. The image contained noises, and the dark brightness region in which the number of contiguous pixels was 5 or less was regarded as the light brightness region, i.e., the structural part, because the noises and pores could not be distinguished from each other. As the method for eliminating the noises, the dark brightness region in which the number of contiguous pixels was 5 or less was excluded in the counting of the number of pixels. The minor axis diameter of the ellipse-like dark brightness region was determined as a minor axis value of a pore, and the major axis diameter of the ellipse-like dark brightness region was determined as a major axis value of a pore. All of pores in a 1 μm×1 μm area were measured. The measurement in a 1 μm×1 μm area was repeated until the total number of measured pores reached 50 or more, and the results were added to data. When two overlapping pores were observed in the depth direction, the exposed part of the pore located at the deeper position was measured. When a portion of a pore was out of the measurement area, the pore was excluded. An average value and a standard deviation were calculated.

(6) Measurement of Opening Ratio in Surface

The surface of a porous membrane was observed with a scanning electron microscope SEM (S-5500, manufactured by Hitachi High-Technologies Corporation) at a magnification of 50,000 times, and an image thereof was captured in a computer. The size of the captured image was 640 pixels×480 pixels. The SEM image was cut into a 6 μm×6 μm piece and the image analysis of the piece was carried out using image processing software. A threshold value was determined by binary coded processing in such a manner that a structural part had a light brightness value and the parts other than the structural part had a dark brightness value, thereby obtaining an image in which the light brightness region was seen as white and the dark brightness region was seen as black. When the structural part could not be distinguished from the parts other than the structural part due to the contrast difference in the image, areas in which the contrasts were same as each other were cut out, the areas were separately subjected to binary coded processing, and then the cut areas were put back together to form a single image. The image contained noises, and the dark brightness region in which the number of contiguous pixels was 5 or less was regarded as the light brightness region, i.e., the structural part, because the noises and pores could not be distinguished from each other. As the method for eliminating the noises, the dark brightness region in which the number of contiguous pixels was 5 or less was excluded in the counting of the number of pixels. An opening ratio was determined by counting the number of pixels in the dark brightness region and then calculating the percentage of the number of the pixels relative to the total number of pixels in the analyzed image. The measurement was carried out on 10 images and an average value thereof was calculated.

(7) Measurement of Thickness of Layer Having Pore Diameter of 130 nm or Less

A porous membrane was wetted by being immersed in water for 5 minutes and then frozen with liquid nitrogen, and the frozen product was folded rapidly, thereby producing a cross section observation sample. The cross section of the porous membrane was observed with a SEM (S-5500, manufactured by Hitachi High-Technologies Corporation) at a magnification of 10000 times, and an image thereof was captured in a computer. The size of the captured image was 640 pixels×480 pixels. In the case where pores present in the cross section were closed when observed with the SEM, the preparation of a sample was retried. The closing of the pores may sometimes occur due to the deformation of the porous membrane in the stress direction in the cutting treatment. The SEM image was cut in a direction parallel to the surface of the porous membrane at a length of 6 μm and in the thickness direction at an arbitrary length, and the image of the resultant area was analyzed using image processing software. The length of the area to be analyzed in the membrane direction may be any length as long as a layer having a pore diameter of 130 nm or less fits within the length. When a dense layer did not fit within the observation field at a measurement magnification, at least two SEM images were synthesized so as to fit the layer having a pore diameter of 130 nm or less within the SEM images. A threshold value was determined by binary coded processing in such a manner that a structural part had a light brightness value and the parts other than the structural part had a dark brightness value, thereby obtaining an image in which the light brightness region was seen as white and the dark brightness region was seen as black. When the structural part could not be distinguished from the parts other than the structural part due to the contrast difference in the image, areas in which the contrasts were same as each other were cut out, the areas were separately subjected to binary coded processing, and then the cut areas were put back together to form a single image. Alternatively, the parts other than the structural part were colored in black and then the resultant image was analyzed. When two overlapping pores were observed in the depth direction, a pore located at a shallower position was measured. When a portion of a pore was out of the measurement area, the pore was excluded. The image contained noises, and the dark brightness region in which the number of contiguous pixels was 5 or less was regarded as the light brightness region, i.e., the structural part, because the noises and pores could not be distinguished from each other. As the method for eliminating the noises, the dark brightness region in which the number of contiguous pixels was 5 or less was excluded in the counting of the number of pixels. The number of pixels in a scale bar which indicated a known length in the image was counted, and the length per pixel was calculated. The number of pixels in the pores was counted, and the result was multiplied by the square of the length per pixel to determine the pore area. The diameter of a circle corresponding to the pore area was calculated in accordance with equation (4) to determine the pore diameter. The pore area corresponding to the pore diameter of 130 nm was 1.3×10⁴ (nm²).

Pore diameter=(pore area/circular constant)^{0.5}×2 (4)

Pores each having a pore diameter of more than 130 nm were identified, and the thickness of a layer in which such pores were not present as observed in the direction perpendicular to the surface of the porous membrane was measured. When the dense layer was not in contact with the surface of the porous membrane, a perpendicular line to the surface was drawn, and the longest distance among the distances between the surface on the perpendicular line and pores each having a pore diameter of less than 130 nm was measured. When the dense layer was in contact with the surface of the porous membrane, the thickness of the dense layer is the distance between the surface of the porous membrane and a pore that is the closest to the surface and has a pore diameter of more than 130 nm. In one image, the measurement was carried out at 5 positions. With respect to 10 images, the measurement was carried out in the same manner, and an average value of 50 measurement data was calculated.

(8) Measurement of Overall Porosity of Porous Membrane

A measurement example in which a porous membrane is a hollow fiber membrane will be mentioned below.

A porous membrane was cut into a 10-cm piece in the length direction, and the mass m (g) of the piece was measured. The porosity P (%) in the porous membrane was calculated from the density a (g/ml) of a material of the porous membrane, and the inner radius rᵢ (cm) and the outer radius rₒ (cm) of the porous membrane in accordance with equation (5) shown below. The measurement was carried out on 10 samples, and an average value was determined.

P=(1−((m/a)/((rₒ×π−rᵢ²×π)×10)))×100 (5)

(9) Measurement of Overall Charge Amount of Porous Membrane

The dry mass of the hollow fiber membrane was measured. At this time, about 0.05 g of the hollow fiber membrane was weighed out. When the hollow fiber membrane could not be titrated due to large charge amount, the mass thereof may properly be made small. The weighed membrane was washed with 20 ml of 0.1 N sodium hydroxide and subsequently washed with distilled water. A 1% phenolphthalein solution was added dropwise to the distilled water after washing, and the hollow fiber membrane was repeatedly washed with distilled water until the membrane was no longer colored. The hollow fiber membrane after washing was dried to have a constant weight by a freeze drying method. The hollow fiber membrane after drying was put into a centrifuge tube having a volume of 50 ml. Then, 20 ml of 0.001 N hydrochloric acid was added thereto so that the hollow fiber membrane was completely soaked in hydrochloric acid. The solution was shaken at 30° C. for 24 hours at a rate of 150 times per minute. After shaking, 10 ml of supernatant of the solution thus shaken was titrated with 0.001 N sodium hydroxide. Two drops of the 1% phenolphthalein solution was added as an indicator. From the titration result, a positive charge density was determined. When the titration was completed by dropping of less than 2 μmol of sodium hydroxide, the measurement was carried out again with a reduced mass of the hollow fiber membrane. When more than 10 ml of titration resulted in a negative value, the hollow fiber membrane carried a negative charge, so that evaluation was carried out with hydrochloric acid and sodium hydroxide being converse to each other. More specifically, 20 ml of a 0.001 N aqueous sodium hydroxide solution was added so that the hollow fiber membrane was completely soaked in the aqueous sodium hydroxide solution. The solution was shaken at 0° C. for 24 hours at a rate of 150 times per minute. After shaking, 10 ml of supernatant of the solution thus shaken was titrated with 0.001 N hydrochloric acid.

The overall charge density of the porous membrane was calculated from equation (6).

E=(V_{H}×N_{H}−V_{N}×N_{N})×2/m (6)

wherein E represents a charge density (μeq/g); V_{H} represents an amount of hydrochloric acid (ml); N_{H} represents a normality of hydrochloric acid (μeq/ml); V_{N} represents a titration value (ml); N_{N} represents a normality of sodium hydroxide (μeq/ml); and m represents a dry mass of a hollow fiber membrane (g).

(10) Zeta Potential of Inner Surface of Hollow Fiber Membrane

Fifty hollow fiber membranes were bundled, then charged in a cylindrical cell having an inner diameter of 15 mm, and fixed to the end of the cylinder with a potting material. The potting material used at this time was polyurethane KC256, KN503 manufactured by Nippon Polyurethane Industry Co., Ltd. The hollow fiber membranes were fixed with the potting material, and one day later, the end face thereof was cut, and the hollow fiber membranes were formed into a cell having a length on the order of 4.5 to 5 cm. The zeta potential was measured with a zeta potential analyzer EKA manufactured by Anton Peer GmbH. In the measurement, the specific conductivity of a measuring solution, and the pressure difference and the electric potential difference between both ends of the cell obtained when the measuring solution was allowed to flow into the cell were determined, and the zeta potential was thereby determined by calculation. The measuring solution thereat was 0.001 N potassium chloride, the volume of the measuring solution was 500 ml, and the measuring pH was 2.5. Before the measurement, the 0.001 N aqueous potassium chloride solution was left overnight in a pot and then measured.

### Example 1

Polysulfone (manufactured by Solvay Corp., “Udel” (registered trade mark) Polysulfone P-3500) (20 parts by mass) and polyvinylpyrrolidone (manufactured by BASF, K30, weight average molecular weight: 40000) (11 parts by mass) were added to a mixed solvent of N,N′-dimethylacetamide (68 parts by mass) and water (1 part by mass), and the resultant mixture was heated at 90° C. for 6 hours to dissolve the components, thereby producing a membrane formation stock solution. The membrane formation stock solution was discharged through an annular slit of a double tube cylindrical spinneret. The outer diameter and the inner diameter of the annular slit were 0.59 mm and 0.23 mm, respectively. As an injection solution, a solution composed of N,N′-dimethylacetamide (75 parts by mass) and water (25 parts by mass) was discharged through an inner tube. The spinneret was kept at 30° C. The discharged membrane formation stock solution was allowed to flow through a dry unit (80 mm) at a dew point of 26° C. (temperature: 30° C., humidity: 80%) in 0.16 seconds, and was then introduced into a water bath (coagulation bath) at 40° C. to be solidified. The solidified product was washed with water at 50° C. and was then wound at a speed of 30 m/min to form a skein, thereby producing a porous membrane having the form of a hollow fiber membrane which had a fiber inner diameter of 180 μm and a thickness of 95 μm. The resultant product was cut into a 20-cm piece in the length direction, and the piece was washed with hot water at 85° C. for 5 hours and was then heated at 100° C. for 2 hours. The porous membrane obtained after the heat treatment was immersed in 1% by mass of an aqueous solution of polyethyleneimine having a molecular weight of 10,000, and was then irradiated with a γ ray of 27 kGy. The irradiated porous membrane was washed with hot water at 85° C. for 5 hours and was then heated at 100° C. for 2 hours.

The porous membrane was subjected to the measurement of water permeability, the measurement of virus-removing performance, the measurement of overall virus adsorption capacity, the measurement of virus adsorption capacity obtained when viruses were brought into contact with one surface of the porous membrane and then allowed to flow, the measurement of pore diameters of the surface, the measurement of opening ratio in the surface, the measurement of thickness of a layer having a pore diameter of 130 nm or less, the measurement of overall porosity, the measurement of overall charge amount, and the measurement of zeta potential of the inner surface of the hollow fiber membrane. The results are shown in Tables 1 and 2.

A porous membrane having a high overall charge amount and a high overall zeta potential; high virus adsorption capacity; a large thickness; and high virus-removing performance and high water permeability due to small pore minor axis diameter in the inner surface was produced.

### Example 2

An experiment was carried out in the same manner as in Example 1, except that a solution composed of 71 parts by mass of N, N′-dimethylacetamide and 29 parts by mass of water was used as the injection solution.

The measurement of the same items as in Example 1 was carried out. The results are shown in Tables 1 and 2.

A porous membrane having a high overall charge amount; high virus adsorption capacity; a large thickness; and high virus-removing performance and high water permeability due to small pore minor axis diameter in the inner surface was produced. However, since the average pore minor axis diameter in the inner surface of the porous membrane in Example 2 was smaller than that of the porous membrane in Example 1, the water permeability of the porous membrane in Example 2 was slightly inferior to that of the porous membrane in Example 1.

### Example 3

An experiment was carried out in the same manner as in Example 2, except that 0.1% by mass of an aqueous solution of polyethyleneimine having a molecular weight of 10,000 was used as the solution to be used for immersion when the porous membrane was irradiated with γ ray.

The measurement of the same items as in Example 1 was carried out. The results are shown in Tables 1 and 2.

A porous membrane having a high overall charge amount; high virus adsorption capacity; a large thickness; and high virus-removing performance and high water permeability due to small pore minor axis diameter in the inner surface was produced. However, since the average pore minor axis diameter in the inner surface of the porous membrane in Example 3 was smaller than that of the porous membrane in Example 1, the water permeability of the porous membrane in Example 3 was slightly inferior to that of the porous membrane in Example 1.

### Comparative Example 1

An experiment was carried out in the same manner as in Example 1, except that the treatment with polyethylene imine was not carried out.

The measurement of the same items as in Example 1 was carried out. The results are shown in Tables 1 and 2.

A porous membrane having a low overall charge amount and a low overall zeta potential; and low virus-removing performance due to low virus adsorption capacity was produced.

### Comparative Example 2

An experiment was carried out in the same manner as in Example 2, except that the treatment with polyethyleneimine was not carried out.

The measurement of the same items as in Example 1 was carried out. The results are shown in Tables 1 and 2.

A porous membrane having a low overall charge amount, and low virus-removing performance due to low virus adsorption capacity was produced.

### Comparative Example 3

An experiment was carried out in the same manner as in Example 2, except that 1% by mass of an aqueous solution of polyethyleneimine having a molecular weight of 600 was used as the solution to be used for immersion when the porous membrane was irradiated with γ ray.

The measurement of the same items as in Example 1 was carried out. The results are shown in Tables 1 and 2.

A porous membrane having a low overall charge amount; low virus adsorption capacity; and low virus-removing performance due to small molecular weight of the polyethyleneimine used for the treatment was produced.

### Comparative Example 4

Polysulfone (manufactured by Solvay Corp., “Udel” (registered trade mark) Polysulfone P-3500) (15 parts by mass) and polyvinylpyrrolidone (manufactured by BASF, K90, weight average molecular weight: 1,200,000) (7 parts by mass) were added to a mixed solvent of N,N′-dimethylacetamide (75 parts by mass) and water (3 parts by mass), and the resultant mixture was heated at 90° C. for 6 hours to dissolve the components, thereby producing a membrane formation stock solution. The membrane formation stock solution was discharged through an annular slit of a double tube cylindrical spinneret. The outer diameter and the inner diameter of the annular slit were 1 mm and 0.7 mm, respectively. As an injection solution, a solution composed of polyvinylpyrrolidone (manufactured by BASF, K30, weight average molecular weight: 40,000) (30 parts by mass), N,N′-dimethylacetamide (55 parts by mass) and glycerol (15 parts by mass) was discharged through an inner tube. The spinneret was kept at 40° C. The discharged membrane formation stock solution was allowed to flow through a dry unit (80 mm) at a dew point of 26° C. (temperature: 30° C., humidity: 80%) in 0.16 seconds, and was then introduced into a water bath (coagulation bath) at 40° C. to be solidified. The solidified product was washed with water at 50° C., and was then wound at a speed of 30 m/min to form a skein. The resultant product was cut into a 20-cm piece in the length direction, and the piece was washed with hot water at 85° C. for 5 hours and was then heated at 100° C. for 2 hours. Then, a porous membrane having the form of a hollow fiber membrane which had a fiber inner diameter of 300 μm and a thickness of 90 μm after heat treatment was produced.

The porous membrane thus obtained was immersed in 1% by mass of an aqueous solution of polyethyleneimine having a molecular weight of 10,000, and then irradiated with a γ ray of 27 kGy. The irradiated porous membrane was washed with hot water at 85° C. for 5 hours and was then heated at 100° C. for 2 hours.

The measurement of the same items as in Example 1 was carried out. The results are shown in Tables 1 and 2.

A porous membrane having a high overall charge amount and a high overall zeta potential; and high virus adsorption capacity but low virus-removing performance due to large pore minor axis diameters in the inner surface and the outer surface and a small thickness of the layer having a pore diameter of 130 nm or less, was produced.

TABLE 1

| | | | | | | Virus adsorption capacity when |
|---|---|---|---|---|---|---|
| | | Thickness | | Virus- | Overall virus | viruses were brought into contact |
| | Inner | of | Water | removing | adsorption capacity of | with one surface of porous |
| | diameter | membrane | permeability | performance | porous membrane | membrane and allowed to flow |
| | (μm) | (μm) | (ml/Pa/hr/m²) | (LRV) | (PFU/g) | (PFU/m²) |
| Example 1 | 180 | 95 | 5.9 | 4.9 | 3.3 × 10¹⁰ | 4.8 × 10¹⁰ |
| Example 2 | 180 | 95 | 2.7 | 4.5 | 2.8 × 10¹⁰ | 4.5 × 10¹⁰ |
| Example 3 | 180 | 95 | 2.5 | 4.3 | 1.1 × 10¹⁰ | 1.7 × 10¹⁰ |
| Comp. Ex. 1 | 180 | 95 | 6.1 | 0 | 7.1 × 10⁹ | 6.1 × 10⁹ |
| Comp. Ex. 2 | 180 | 95 | 3.2 | 0.8 | 6.8 × 10⁹ | 5.3 × 10⁹ |
| Comp. Ex. 3 | 180 | 95 | 0.68 | 3.2 | 6.9 × 10⁹ | 7.1 × 10⁹ |
| Comp. Ex. 4 | 300 | 90 | 70 | 0 | 2.5 × 10¹⁰ | 4.1 × 10¹⁰ |

TABLE 2

| | | Opening | | Opening |
|---|---|---|---|---|
| | Average minor | ratio in | Average minor | ratio in |
| | axis diameter | inner | axis diameter in | outer |
| | in inner surface | surface | outer surface | surface |
| | (nm) | (%) | (nm) | (%) |
| Example 1 | 21 | 5.3 | 361 | 1.6 |
| Example 2 | 17 | 9.1 | 210 | 3.5 |
| Example 3 | 17 | 9.1 | 210 | 3.5 |
| Comp. Ex. 1 | 21 | 5.3 | 361 | 1.6 |
| Comp. Ex. 2 | 17 | 9.1 | 210 | 3.5 |
| Comp. Ex. 3 | 17 | 9.1 | 210 | 3.5 |
| Comp. Ex. 4 | 417 | 8.4 | 301 | 32 |

TABLE 3

| | Layer having pore | | Layer having pore | | | | |
|---|---|---|---|---|---|---|---|
| | diameter of 130 nm or | | diameter of 130 nm or | | | | |
| | less on inner surface side | | less on outer surface side | | | | |
| | | Presence | | Presence | | | |
| | | or absence | | or absence | | Overall | |
| | | of pore | | of pore | | charge density | |
| | | having pore | | having pore | | of porous | Zeta |
| | Thickness | diameter of | Thickness | diameter of | Porosity | membrane | Potential |
| | (μm) | 100 to 130 nm | (μm) | 100 to 130 nm | (%) | (μeq/g) | mV |
| Example 1 | 2.5 | Present | 7.1 | Present | 70 | 4.2 | 30 |
| Example 2 | 1.9 | Present | 5.3 | Present | 68 | 4.3 | 30 |
| Example 3 | 1.9 | Present | 5.3 | Present | 68 | −11.2 | 24 |
| Comp. Ex. 1 | 2.5 | Present | 7.1 | Present | 70 | −48.7 | 19 |
| Comp. Ex. 2 | 1.9 | Present | 5.3 | Present | 68 | −50.1 | 19 |
| Comp. Ex. 3 | 1.9 | Present | 5.3 | Present | 68 | −45.2 | 21 |
| Comp. Ex. 4 | 0 | Absent | 0.4 | Absent | 82 | 3.8 | 29 |

1-20. (canceled)

21. A porous membrane having an average pore minor axis diameter of 10 nm to 90 nm in at least one surface of the porous membrane; a thickness of 60 μm to 300 μm; and an overall adsorption capacity with respect to bacteriophage MS2 of 8×10⁹ PFU/g or more.

22. The porous membrane according to claim 21, wherein a pore diameter in a cross section of the membrane in a thickness direction varies in the thickness direction of the porous membrane.

23. The porous membrane according to claim 22, wherein a layer having a pore diameter of 130 nm or less in a cross section of the membrane in the thickness direction exists with a thickness of 0.5 μm to 40 μm.

24. The porous membrane according to claim 22, wherein near a surface of a side where the average pore minor axis diameter in the surface of the porous membrane is small, a layer having a pore diameter of 130 nm or less in a cross section of the membrane in the thickness direction exists with a thickness of 0.5 μm to 20 μm, and the layer has a pore having a pore diameter of 100 nm or more and 130 nm or less.

25. The porous membrane according to claim 22, wherein near a surface of a side where the average pore minor axis diameter in the surface of the porous membrane is large, a layer having a pore diameter of 130 nm or less in a cross section of the membrane in the thickness direction exists with a thickness of 0.5 μm to 20 μm, and the layer has a pore having a pore diameter of 100 nm or more and 130 nm or less.

26. The porous membrane according to claim 24, wherein an adsorption capacity when the aqueous bacteriophage MS2 solution is brought into contact with a surface on the side of the layer having a pore diameter of 130 nm or less in a cross section of the membrane in the thickness direction and is then allowed to flow is 1×10¹⁰ PFU/m² or more.

27. The porous membrane according to claim 25, wherein an adsorption capacity is 1×10¹⁰ PFU/m² or more when an aqueous bacteriophage MS2 solution is brought into contact with the layer having a pore diameter of 130 nm or less in a cross section of the membrane in the thickness direction of the porous membrane and is then allowed to flow.

28. The porous membrane according to claim 22, wherein pore diameters in a cross section of the membrane in the thickness direction increase from one surface toward the other surface to have at least one maximum pore diameter and then decrease.

29. The porous membrane according to claim 21, wherein the porous membrane has an overall charge density of −30 μeq/g or more.

30. The porous membrane according to claim 21, comprising a hydrophilic substance in an overall content in the porous membrane of 2% by mass or less.

31. The porous membrane according to claim 21, comprising a second hydrophobic substance which is different from a first hydrophobic substance of a base material of the porous membrane, an overall content of the second hydrophobic substance in the porous membrane being 0.1% by mass or more of a total content of the first and second hydrophobic substances.

32. The porous membrane according to claim 21, wherein at least one of two surfaces of the porous membrane has a zeta potential of 20 mV or more at pH 2.5.

33. The porous membrane according to claim 21, comprising a hydrophilic substance in a content in at least one of two surfaces of the porous membrane of 18% by mass or less.

34. The porous membrane according to claim 21, wherein a base material of the porous membrane contains a first hydrophobic substance and a second hydrophobic substance which is different from the first hydrophobic substance, and a content of the second hydrophobic substance in at least one of two surfaces of the porous membrane is 5% by mass or more.

35. The porous membrane according to claim 21, being a hollow fiber membrane.

36. The porous membrane according to claim 35, wherein an average pore minor axis diameter in an inner surface of the porous membrane is smaller than that in an outer surface of the porous membrane.

37. The porous membrane according to claim 22, wherein a liquid is allowed to flow from a side where the average pore minor axis diameter in the surface of the porous membrane is large toward a side where the average pore minor axis diameter is small.

38. The porous membrane according to claim 21, being used in virus-removing applications.

39. The porous membrane according to claim 38, being used for removing one or more viruses among norovirus, sapovirus, astrovirus, enterovirus, rotavirus, hepatitis A virus, hepatitis E virus, adenovirus, and poliovirus.

40. A water purifier comprising the porous membrane according to claim 21.
